(19) United States
(12) Patent Application Publication
(10) Pub. No.: US 2018/0095798 A1
(43) Pub. Date: Apr. 5, 2018

(54) METHOD AND APPARATUS FOR SOFTWARE PERFORMANCE TUNING WITH DISPATCHING

(71) Applicant: BARRACUDA NETWORKS, INC., Campbell, CA (US)

(72) Inventors: Aaron Kluck, Ann Arbor, MI (US); Jason D. Dictos, Fresno, CA (US)

(21) Appl. No.: 15/413,315

(22) Filed: Jan. 23, 2017

Related U.S. Application Data
(60) Provisional application No. 62/404,712, filed on Oct. 5, 2016.

(51) Int. Cl. G06F 9/50; G06F 11/30

(52) U.S. Cl. CPC G06F 9/5027; G06F 11/3024; G06F 9/5011

(57) ABSTRACT

A new approach is proposed that contemplates systems and methods to support performance tuning of software running on a host/computing device. Specifically, a performance tuner is assigned to and associated with each background process running on the host, wherein the performance tuner is configured to monitor system resource usage by the background process in real time via a plurality of handlers deployed to a plurality of types of system resources of the host. Here, the system resources include but are not limited to CPU, memory/storage, and bandwidth of the network connections of the host. If the system resource usage by the background process is too high (e.g., causing performance degradation of foreground processes viewed/used by a user of the host), the performance tuner is configured to dynamically dispatch the background process—slow it down to scale back its system resource usage.

### CROSS-REFERENCE TO RELATED APPLICATIONS

This application claims the benefit of U.S. Provisional Patent Application No. 62/404,712, filed Oct. 5, 2016, and entitled “Method and apparatus for software performance tuning with dispatching,” which is incorporated herein in its entirety by reference.

### BACKGROUND

While using a computing device, such as a personal computer (PC) or a server, a user/operator of the computing device may assume that only the foreground processes that he/she is currently viewing and/or interacting with would consume system resources of the computing device in terms of, for non-limiting examples, CPU, memory and storage, and bandwidths of network communication links. In reality, however, a significant amount of the system resources of the computing device are consumed by processes running in the background, causing a degradation of performance of the foreground processes and the real time experience of the user.

It is often difficult (if not impossible) to know up front the amount of system resources that a background process can safely consume without degrading the performance of a foreground process of a computing device. This is because, by its nature, the computing device is configured to serve a wide variety of functions simultaneously with no predictable usage pattern of its system resources. As such, it is important to be able to monitor the system resources consumed by the background processes as they are running and to adjust these background processes accordingly to avoid performance degradation for the foreground processes the user is viewing/accessing when the background processes consume too much system resources of the computing device.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support software performance tuning with dispatching in accordance with some embodiments.

FIG. 2 depicts a diagram of an example of how requests flow through components of system depicted in FIG. 1 in accordance with some embodiments.

FIG. 3 depicts a diagram of an example to illustrate how a background process spends its time working or dispatching at varying levels of utilization of the system resources in accordance with some embodiments.

FIG. 4 depicts a flowchart of an example of a process to support software performance tuning with dispatching in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support performance tuning of software running on a host/computing device. Specifically, a performance tuner is assigned to and associated with each background process running on the host, wherein the performance tuner is configured to monitor system resource usage by the background process in real time via a plurality of handlers deployed to a plurality of types of system resources of the host. Here, the system resources include but are not limited to CPU, memory/storage, and bandwidth of the network connections of the host. If the system resource usage by the background process is too high (e.g., causing performance degradation of foreground processes viewed/used by a user of the host), the performance tuner is configured to dynamically dispatch the background process—slow it down to scale back its system resource usage.

By monitoring the system resource usage by the background processes in real time and dynamically dispatching the background processes, the proposed approach enables the foreground processes/applications directly accessed, viewed and/or used by the user on the host can have enough system resources to run so that the user will not experience any performance degradation. The approach is generically applicable across any kind of background processes, which is dispatched based on input/instructions from the performance tuner, without affecting implementations of the foreground and/or background processes on various kinds of hosts/devices. For a non-limiting example, besides a client side device, the approach can also be applied to monitor system resource usage on a backend server so that users running critical applications on the server can have high priorities in terms of system resource allocations.

As referred to herein, a foreground process is a computer program a user/operator of the computing device can view and interact with directly, which can be but is not limited to a graphical user interface (GUI), a word processor, a Web browser, or a media player. A foreground process usually does not consume significant system resources of the computing device unless directed to perform certain task(s) by the user. A background process, on the other hand, is a computer program that performs a valuable service but is not visible to the user, which can be but is not limited to antivirus software, a firewall, or a file backup utility. For the following discussions, the term background process also refers to a foreground process that performs resource-consuming tasks in the background without direct user interaction.

As referred to herein, the system resources includes various type of resources of the computing device that can be made available to the foreground and the background processes at limited rate per unit time, such as CPU instructions, hard disk operations, and bandwidth of network interface for packet transfers. For simplicity, these system resources can be measured in terms of percentage of maximum throughput. Since the computing device has only finite amount of system resources available at any given time, a process consuming certain type of system resource will not be able to use as much as it wants in a given time if 100% of that particular resource is being consumed, resulting in the process running slower than it otherwise would. For a foreground process, such performance degradation would leads directly to user frustration or loss of productivity. For non-limiting examples, a document may take longer to open, user interactions with a foreground process may take longer to yield a result (and may appear unresponsive), or communication with other devices may not work as designed.

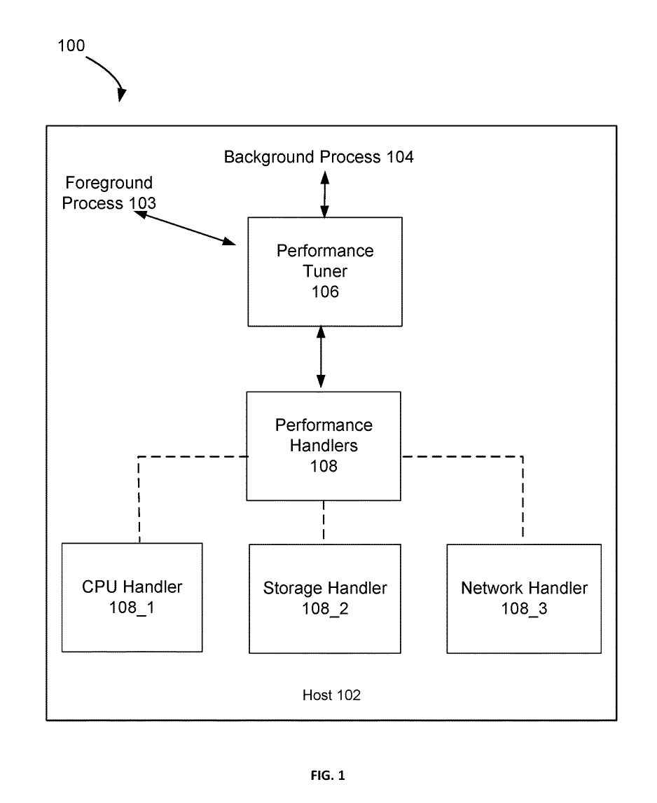

FIG. 1 depicts an example of a system diagram 100 to support software performance tuning with dispatching. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least a performance tuner 106 and one or more performance handlers 108 associated with a background process 104 running on a computing device/host 102 having one or more processors, storage units, and network interfaces. The background process 104, the performance tuner 106, and the handlers 108 each includes software instructions stored in a storage unit such as a non-volatile memory (also referred to as secondary memory) of the host 102 for practicing one or more processes. When the software instructions are executed the processor of the host, at least a subset of the software instructions is loaded into memory (also referred to as primary memory) by the host 102, which becomes a special purposed one for practicing the processes. The processes may also be at least partially embodied in the host into which computer program code is loaded and/or executed, such that, the host becomes a special purpose computing unit for practicing the processes. When implemented on a general-purpose computing unit, the computer program code segments configure the computing unit to create specific logic circuits.

In the example of FIG. 1, the host 102 can be a computing device, a communication device, a storage device, or any computing device capable of running a software component. For non-limiting examples, a computing device can be but is not limited to a laptop PC, a desktop PC, a tablet PC, or an x86 or ARM-based a server running Linux or other operating systems. In some embodiments, each host has a communication interface, which enables the above components running on the host 102 to communicate with other applications, e.g., a Web application or site, following certain communication protocols, such as TCP/IP, http, https, ftp, and sftp protocols, over one or more communication networks (not shown). The communication networks can be but are not limited to, internet, intranet, wide area network (WAN), local area network (LAN), wireless network, Bluetooth, WiFi, and mobile communication network. The physical connections of the network and the communication protocols are well known to those of skill in the art.

In the example of FIG. 1, the performance tuner 106 is associated with or resides within a background process 104 and is configured to monitor system resources consumed by the background process 104 and to artificially slow the background process 104 down if the system resources it consumes become over-utilized. As discussed above, the types of system resources monitored by the performance tuner 106 include but are not limited to CPU, storage, and network bandwidth. When a component of an application/foreground process 103 performs work that might consume the system resources, the foreground process 103 may ask the performance tuner 106 to dispatch the background process 104 to free up one or more types of the system resources the foreground process 103 may need to consume. When asked to dispatch the one or more types of the system resources, the performance tuner 106 is configured to check the current utilization of those types of system resources and artificially pause or put to sleep execution of the background process 104 that currently consume those system resources for a brief period of time if the system resources are overly consumed, in order to free up the system resources for the foreground process 103 to consume instead. If the background process 104 consumes more than one types of the system resources, the period of time is the maximum of the dispatch intervals (discussed below) determined individually for each of the types of the system resources based on their configurations and current utilizations. In some embodiments, the performance tuner 106 is configured to dispatch the background process 104 (and free up the system resources it currently consumes) after the background process 104 has performed certain amount of work, for example, having processed a certain number of bytes or having performed a certain number of iterations of a loop.

In some embodiments, the performance tuner 106 includes and assigns one or more performance handlers 108, each of the performance handlers 108 each configured to collect usage data about a specific type of system resource it has been assigned to and to calculate a dispatch interval of the type of system resource based on the data collected. Here, the dispatch interval is a period of time that is variable and depends on configuration and the current utilization of the system resources. Since a background process might have consume different types of system resources, a single, customized performance handler 108 may be assigned to and installed for each resource type, e.g., CPU handler 108_1, storage handler 108_2, and network handler 108_3. Having the performance handlers 108, not the performance tuner 106, dedicated to the resource types allows for simpler application-level configuration. It also improves reusability of the performance tuner 106 across different applications/background processes 104, each of which may need different performance handlers 108 for the same type of system resource.

When the performance tuner 106 is asked to dispatch for a particular type of system resource, the request is passed to a performance handler 108 assigned to that type of system resource, which is configured to determine the dispatch interval for that type of system resource based on its collected data. In some embodiments, the performance handler 108 may use determine a utilization percentage of a type of system resource based on the collected data, wherein the resource utilization percentage is then multiplied by the dispatch interval. In some embodiments, no pause of the background process 104 will occur if no performance handler 108 is installed for the types of system resources consumed by the background process 104. In some embodiments, a minimum dispatch interval may be provided for each type of the system resources regardless of whether a performance handler 108 is installed or not. In some embodiments, multiple performance handlers 108 are assigned to the same type of system resource, wherein the performance handlers 108 are configured to measure the type of system resource and/or compute its dispatch interval in different ways. The performance tuner 106 is then configured to customize or configure the usage data and/or dispatch intervals for the type of system resource based on the data from the multiple performance handlers 108.

In some embodiments, the performance tuner 106 is configured to collect usage measurement data of the system resources (e.g., total amount of system resource used) from its performance handlers 108 at any time either individually for each type of system resource or all types of system resources at once. In some embodiments, data collection can be scheduled to repeat whenever a specific collection interval of time has passed, e.g. every 5 seconds, for consistent results and the performance tuner 106 is configured to compare the usage data of the system resources from two consecutive collections. The shorter the collection interval, the faster the performance tuner 106 can adapt to changes in resource utilization. However, although the cost in terms of system resources to collect this data is small, it is nonzero, so the collection interval should not be too short.

In some embodiments, the performance handler 108_1 assigned to collect usage data of CPU of the host 102 is configured to measure the CPU utilization by a background process 104 to prevent the background process from consuming too much CPU cycles, regardless of how busy the rest of the system resources are. In some embodiments, CPU handler 108_1 is configured with a maximum dispatch interval. When dispatching, the dispatch interval is calculated as the percentage of CPU utilization by the background process 104 itself, multiplied by the maximum dispatch interval. In some embodiments, the CPU handler 108_1 is configured to calculate the percentage of CPU utilization by inquiring operating system (OS) of the host 102 for the total amount of time the background process 104 has spent using the CPU (usually given in microseconds or hundreds of nanoseconds). The value is then compared to the previous collected data and the difference is divided by the elapsed time between the two consecutive data collections. If the host 102 has multiple CPU cores, this value may need to be divided by the number of CPU cores in the host 102.

In some embodiments, the CPU handler 108_1 is configured to measure the CPU utilization of the entire host 102 to prevent the system 100 as a whole from using too much CPU regardless of how busy the background process 104 is. When dispatching, the dispatch interval of the CPU is calculated as the percentage of CPU utilization of the entire system multiplied by a maximum dispatch interval. Depending on the host 102, the CPU handler 108_1 may inquire the OS about how much time the CPU was idle then subtract the resulting percentage from 100%.

In some embodiments, the performance handler 108_2 assigned to collect usage data of storage of the host 102 is configured to measure the entire host's utilization of a single storage device, e.g., a hard disk, to prevent the system 100 as a whole from experiencing too much disk latency, regardless of how busy the background process 104 is. In some embodiments, the storage handler 108_2 is configured with a maximum dispatch interval. When dispatching, the average disk latency is multiplied by a constant that produces a value between 0-100% for latencies common to desktop hard disks, which is then multiplied by the maximum dispatch interval. In some embodiments, the storage handler 108_2 is configured to calculate the average disk latency by inquiring the OS about the total amount of time that has been spent on the storage, along with how many disk operations have been performed in total. These are compared to data from a previous collection and the difference in time spent is divided by the difference in the number of operations to get an average of time spent per operation.

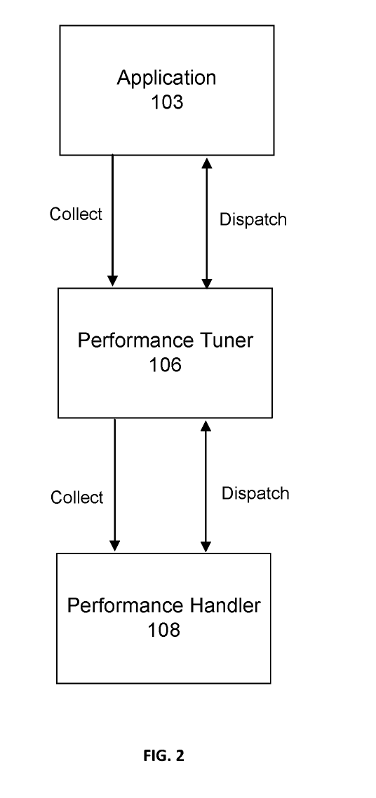

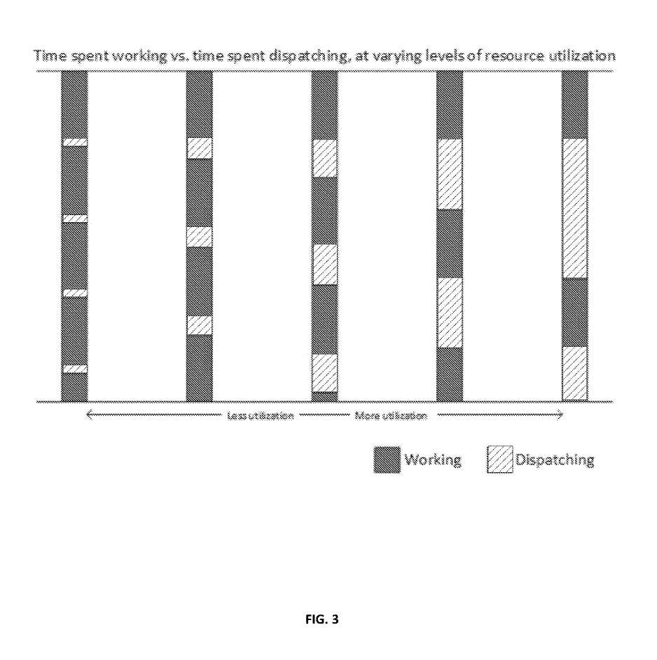

FIG. 2 depicts a diagram of an example of how requests flow through components of system 100 depicted in FIG. 1. As shown in the example of FIG. 2, an application/foreground process 103 requests the performance tuner 106 of a backend process 104 to collect data about one or more types of system resources it is to consume and backend process 104 passes the request to its performance handler(s) 108 assigned to various types of system resources. The application 103 may also ask the performance tuner 106 to dispatch, which in turn passes the dispatching request to its performance handler(s) 108. The performance handler(s) 108 calculates and passes the dispatch intervals of the various types of system resources back to the performance tuner 106, which either pauses its backend process 104 for that period of time and/or passes the values of the dispatch intervals back to the component of the application 103 that asked for the dispatching. FIG. 3 depicts a diagram of an example to illustrate how the background process 104 spends its time working or dispatching at varying levels of utilization (increasing from left to right) of the system resources of the host 102.

In some embodiments, an external event associated with the application/foreground process 103 may occur, wherein such event can be but is not limited to, the user moves mouse, a remote user accesses a file system, etc. Such event can be an external trigger, which, when detected by the performance tuner 106, causes the dispatching of the background process 104 to increase or decrease consumption of the system resources of the host 102. For a non-limiting example, if the user is currently moving the mouse or interacting with the login process to the host 102, such event may cause the allocated system resources for the background process 104 to be briefly lowered to ensure a smooth user experience. In some embodiments, external triggers can also be detected when the user browses a network share or any other system detectable event which may imply that the system resources should be briefly re-allocated. In some embodiments, the external event may be associated with a process that is not limited to a foreground process but can be another background process of a higher priority, which for a non-limiting example, can be a Samba process serving up files to implement network protocols. When an external trigger associated with such background process is detected by the performance tuner 106, it may cause dispatching of the background process 104 to temporarily limit its consumption of the system resources of the host 102.

In some embodiments, a plurality of profiles can be defined for each system state, which are pre-defined limits the types of system resources when dispatching the background process 104. Here, profiles may switch depending on the current external triggers wherein a maximum use state is defined in the case of no external triggers being active. As such, the system 100 can dynamically scale up or down and quality of service in terms of user experiences can be guaranteed. For a non-limiting example, the background process 104 may be in a maximum use state consuming up to 100% of the CPU. If an external trigger is detected, that percentage may be lowered to 50% for a specified amount of time (dispatch interval) until the external trigger is no longer detected.

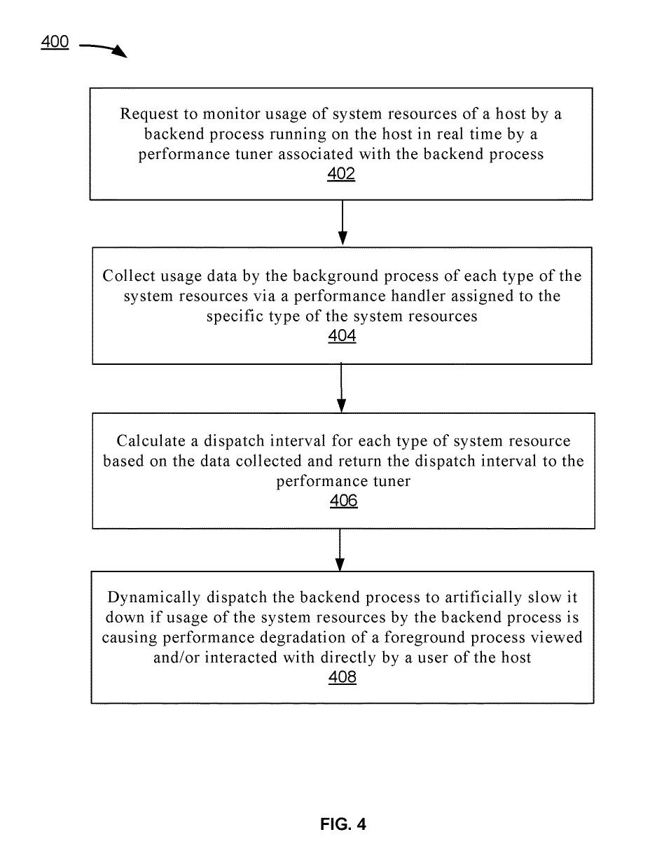

FIG. 4 depicts a flowchart 400 of an example of a process to support software performance tuning with dispatching. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 4, the flowchart 400 starts at block 402, where monitoring of usage of system resources of a host by a backend process running on the host in real time is requested via a performance tuner associated with the backend process. The flowchart 400 continues to block 404, where usage data by the background process of each type of the system resources is collected via a performance handler assigned to the specific type of the system resources. The flowchart 400 continues to block 406, where a dispatch interval for each type of system resource is calculated based on the data collected and returned to the performance tuner. The flowchart 400 ends at block 408, where the backend process is dynamically dispatched to artificially slow it down if usage of the system resources by the backend process is causing performance degradation of a foreground process viewed and/or interacted with directly by a user of the host.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support software performance tuning with dispatching, comprising:
a performance tuner associated with a backend process running on a host, wherein the performance tuner is configured to
request to monitor usage of system resources of the host by the backend process in real time via one or more performance handlers;
dynamically dispatch the backend process to artificially slow it down if usage of the system resources by the backend process is causing performance degradation of a foreground process viewed and/or interacted with directly by a user of the host;
said one or more performance handlers associated with the performance tuner, wherein each performance handler is assigned to a type of the system resources of the host and configured to
collect usage data by the background process of the specific type of system resource it has been assigned to; and
calculate a dispatch interval of the type of system resource based on the data collected and return the dispatch interval to the performance tuner.

2. The system of claim 1, wherein:
the system resources are of one or more types of CPU instructions, storage operations, and network bandwidth that that are made available to the foreground and the background processes at limited rate per unit time.

3. The system of claim 1, wherein:
the background process is a computer program running on the host that performs a service but is not visible to the user.

4. The system of claim 1, wherein:
the foreground process is one of a graphical user interface (GUI), a word processor, a Web browser, and a media player.

5. The system of claim 1, wherein:
the performance tuner is configured to dispatch the background process to conserve one or more types of the system resources the foreground process needs to consume upon a request by the foreground process.

6. The system of claim 5, wherein:
the performance tuner is configured to check current utilization of those types of system resources and artificially pause or put to sleep execution of the background process that currently consumes those system resources for a period of time if the system resources are overly consumed.

7. The system of claim 6, wherein:
the period of time is the maximum of the dispatch intervals determined individually for the types of the system resources if the background process consumes more than one types of the system resources.

8. The system of claim 1, wherein:
the dispatch interval is a period of time that is variable and depends on configuration and the current utilization of the type of the system resources.

9. The system of claim 1, wherein:
the performance tuner is configured to dispatch the background process after the background process has performed certain amount of work.

10. The system of claim 1, wherein:
the performance tuner is configured to assign multiple performance handlers to the same type of system resources, wherein each performance handler is configured to measure usage data of the type of system resources and/or calculate its dispatch interval in different ways.

11. The system of claim 10, wherein:
the performance tuner is configured to customize or configure the usage data and/or the dispatch interval for the type of system resources based on the data from the multiple performance handlers.

12. The system of claim 1, wherein:
the performance tuner is configured to collect the usage data of the system resources from its performance handlers repeatedly whenever a specific collection interval of time has passed.

13. The system of claim 12, wherein:
the performance tuner is configured to compare the usage data of the system resources from two consecutive collections.

14. The system of claim 1, wherein:
the performance handler assigned to collect usage data of CPU of the host is configured to measure CPU utilization by the background process to prevent the background process from consuming too much CPU cycles.

15. The system of claim 14, wherein:
the performance handler assigned to the CPU of the host is configured to calculate the dispatch interval of the CPU as a percentage of CPU utilization of the entire system multiplied by a maximum dispatch interval.

16. The system of claim 1, wherein:
the performance handler assigned to collect the usage data of storage of the host is configured to measure utilization of a single storage device by the host to prevent the system as a whole from experiencing too much disk latency regardless of how busy the background process is.

17. The system of claim 1, wherein:
the performance tuner is configured to detect an external event associated with the foreground process or another background process, which when occurs, causes the dispatching of the background process to increase or decrease consumption of the system resources of the host.

18. The system of claim 1, wherein:
the performance tuner is configured to dispatch the background process according to a plurality of profiles, which are pre-defined limits for the types of system resources when dispatching the background process.

19. A computer-implemented method to support software performance tuning with dispatching, comprising:
requesting to monitor usage of system resources of a host by a backend process running on the host in real time by a performance tuner associated with the backend process;
collecting usage data by the background process of each type of the system resources via a performance handler assigned to the specific type of the system resources;
calculating a dispatch interval for each type of system resource based on the data collected and returning the dispatch interval to the performance tuner;
dynamically dispatching the backend process to artificially slow it down if usage of the system resources by the backend process is causing performance degradation of a foreground process viewed and/or interacted with directly by a user of the host.

20. The method of claim 19, further comprising:
dispatching the background process to conserve one or more types of the system resources the foreground process needs to consume upon a request by the foreground process.

21. The method of claim 20, further comprising:
checking current utilization of those types of system resources and artificially pause or put to sleep execution of the background process that currently consumes those system resources for a period of time if the system resources are overly consumed, wherein the period of time is the maximum of the dispatch intervals determined individually for the types of the system resources if the background process consumes more than one types of the system resources.

22. The method of claim 19, further comprising:
dispatching the background process after the background process has performed certain amount of work.

23. The method of claim 19, further comprising:
assigning multiple performance handlers to the same type of system resources, wherein each performance handler is configured to measure usage data of the type of system resources and/or calculate its dispatch interval in different ways.

24. The method of claim 23, further comprising:
customizing or configuring the usage data and/or the dispatch interval for the type of system resources based on the data from the multiple performance handlers.

25. The method of claim 19, further comprising:
collecting the usage data of the system resources from the performance handlers repeatedly whenever a specific collection interval of time has passed.

26. The method of claim 25, further comprising:
comparing the usage data of the system resources from two consecutive collections.

27. The method of claim 19, further comprising:
measuring CPU utilization by the background process via the performance handler assigned to collect usage data of CPU of the host to prevent the background process from consuming too much CPU cycles.

28. The method of claim 27, further comprising:
calculating the dispatch interval of the CPU as a percentage of CPU utilization of the entire system multiplied by a maximum dispatch interval.

29. The method of claim 19, further comprising:
measuring utilization of a single storage device by the host via the performance handler assigned to collect the usage data of storage of the host to prevent the system as a whole from experiencing too much disk latency regardless of how busy the background process is.

30. The method of claim 19, further comprising:
detecting an external event associated with the foreground process or another background process, which when occurs, causes the dispatching of the background process to increase or decrease consumption of the system resources of the host.

31. The method of claim 19, further comprising:
dispatching the background process according to a plurality of profiles, which are pre-defined limits for the types of system resources when dispatching the background process.

32. At least one computer-readable storage medium having computer-executable instructions embodied thereon, wherein, when executed by at least one processor, the computer-executable instructions cause the at least one processor to:
request to monitor usage of system resources of a host by a backend process running on the host in real time by a performance tuner associated with the backend process;
collect usage data by the background process of each type of the system resources via a performance handler assigned to the specific type of the system resources;
calculate a dispatch interval for each type of system resource based on the data collected and return the dispatch interval to the performance tuner;
dynamically dispatch the backend process to artificially slow it down if usage of the system resources by the backend process is causing performance degradation of a foreground process viewed and/or interacted with directly by a user of the host.
